(19) United States
(12) Patent Application Publication
(10) Pub. No.: US 2004/0129811 A1
(43) Pub. Date: Jul. 8, 2004

(54) Two roll sugarcane crushing mill

(76) Inventor: Bhausaheb Bapurao Nikam, Sadashiv Peth (IN)

Correspondence Address: HARRISON & EGBERT, 412 MAIN STREET, 7TH FLOOR, HOUSTON, TX, 77002, US

(21) Appl. No.: 10/476,802

(22) PCT Filed: May 11, 2001
(86) PCT No.: PCT/IN01/00101

(51) Int. Cl. B02C 19/12

(52) U.S. Cl. 241/159

(57) ABSTRACT

An improved two roll sugarcane crushing mill is provided by the present invention comprising a plurality of improved two roll mill modules in tandem, each comprising a pair of main crushing rolls consisting of bottom and top roll. The bottom and the top rolls are rotatingly mounted in a pair of main frames/head stock and a pair of top beams/lever arms at the two end respectively. One end of each of the top beams is pivotally attached near upper end of the head stocks towards feed side for swinging top beams along with top roll. At least one feeder roller is provided with a scrapper cum deflector with juice drainage means in the close proximity of the main crushing rolls. The feeder rollers are mounted on an auxiliary frame which is rigidly/pivotally mounted on main frame to adjust the loading/setting the feeder roller in desired position.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to an improved two roll sugarcane-crushing mill. More particularly this invention relates to a two roll sugarcane crushing mill in which multiple feeder rollers are used, without needing a closed stationary pressure chute for compressed/compact feeding of prepared cane/bagasse mat and in which pivoted hydraulic system attached to a lever arm for free floating top roll is provided to give more loading at less hydraulic pressure and at the same time easy dismantling of top and bottom rolls, and reduced hydraulic seal failure resulting into low maintenance cost, less power consumption and same performance, as of existing mill, with less number of mill modules/rolls.

### BACKGROUND OF THE INVENTION

In the conventional two roll sugarcane crushing mill a plurality of two roll mill modules are used in tandem. Each of the two roll mill module comprises a bottom roll and top roll mounted in a pair of closed frame/headstock provided at the two ends, for allowing the cane/bagasse feeding between the two rolls, these rolls are kept inclined, instead of vertical, that is the central axis of top and bottom rolls is inclined at about 25 degree from the vertical axis. The top roll is directly loaded to press the same towards the bottom roll. For this top roll bearings slide in the headstock/frame at the two ends of the top roll.

Sometime on feeder roller which is generally a grooved roller fixedly mounted on the frame, without any scraper-cum-deflector, is provided to compress/compact the prepared cane/bagasse mat for feeding between the two rolls.

When two or more feeder rollers are used for compressing/compacting the cane/bagasse mat to be into the gap between the two rolls, a stationary closed pressure chute is also required to be provided between the feeder rollers and main crushing rolls.

The main draw backs of the conventional two roll sugarcane crushing mill are as given below:

i) The top and bottom rolls being mounted in the inclined position, top roll bearings slide in the inclined plane resulting in side friction on the bearings and more functional load and more maintenance.

ii) The top roll is directly loaded to press it against the bottom roll for which top roll bearings slide in the head stock at the two ends, and are subjected to uneven wear at top and bottom sides, resulting into sluggish floating of the top roll instead of free floating.

iii) The top roll being directly loaded and central axis of top and bottom rolls being inclined more hydraulic load is required needing more power consumption for a desired load.

iv) Hydraulic cylinder being rigidly mounted in an inclined plane for direct loading of top roll, hydraulic seal failure is considerably more.

v) In case of a single feeder roller provided for compact feeding of cane/bagasse the compressed cane is again expanded, as there is no scrapper/deflector provided with the feeder roller, thereby gripping angle of the main crushing rolls is increased resulting into reduced cane crushing capacity of the mill, and higher power consumption due to more number of rolls.

vi) As there is no scraper or any other juice removing means like lotus type construction provided with the feeder roller, juice is not removed by the feeder roller, resulting into lower juice extraction efficiency/capacity of the mill and more power consumption as more number of rolls will be required for the same juice extraction capacity of the mill.

vii) As the top and bottom rolls are mounted in a pair of closed frames and are directly loaded, while dismantling the rolls for maintenance and/or repairing the top cap with hydraulic loading means is also to be removed and then only the top and bottom rolls are lifted upwards, which takes more time and labor, thus besides higher maintenance cost, mill down time is also more, resulting in lower productivity of the crushing mill.

viii) In case of two or more feeder rollers needing a stationery closed pressure chute provided between the feeder rollers and the main crushing rolls, all the inherent drawbacks of the stationary closed pressure chute, which are well known and described in my co pending patent application No 32/130M/93, are there, resulting into higher initial cost and maintenance cost, more mill down time, more power requirement and lower productivity of the mill.

Objects of the Invention

The main object of this invention is to obviate the above mentioned drawbacks of the existing two roll sugarcane crushing mill and to provide an improved two roll sugar cane crushing mill wherein the top and bottom rolls are mounted in a pair of open main frames, keeping the central axis of top and bottom rolls in substantially vertical position, instead of inclined as in conventional mills for giving more effective pressure on the prepared cane/bagasse mat, passing through the gap in between the top and bottom roll and wherein the pressure on the top rolls is applied through a leverage pivoted towards feed side instead of direct loading, as in conventional mills, for using less power and working hydraulic pressure for the same load.

Another object of this invention is to provide an improved two roll sugarcane crushing mill wherein the hydraulic cylinder for loading the top roll is pivotally and flexibly mounted at the end of a lever arm to give free floating of the top roll and reducing the chances of hydraulic seal/system failure considerably, thereby low maintenance and mill down time, giving higher productivity.

A further object of this invention is to provide a two roll sugarcane crushing mill wherein for maintenance and or repair, the top and bottom rolls are removed very easily from the open side of the frame, without completely removing the hydraulic loading system means, thus the time taken and man-power required for maintenance are reduced considerably thereby reducing the maintenance cost and increasing the productivity of the mill.

A further object of this invention is to provide an improved two roll sugarcane crushing mill wherein multiple (two or more) feeder rollers with or without scraper-cum-deflector can be provided without needing a stationary closed pressure chute for achieving an additional compression of the cane/bagasse, increasing juice extraction capacity and productivity of the mill.

A further object of this invention is to provide an improved two roll sugarcane crushing mill wherein a single feeder roller is provided with scraper-cum-deflector, so that cane/bagasse mat once compressed will not expand and thereby gripping angle is much reduced and thus increasing the feedability cane crushing capacity of the mill, with less number of rolls and hence reducing the power required for the mill, considerably.

A further object of this invention is to provide an improved two roll sugarcane crushing mill wherein the bottom crushing roll is of substantially larger diameter than the top roll and the central axis is kept substantially vertical to allow increased free flow of juice by gravity.

A further object of this invention is to provide an improved two roll sugarcane crushing mill wherein the last mill module of the mill tandem may be an existing type three roll mill to exhaust low moisture content bagasse from the final stage of the sugar cane crushing mill.

### BRIEF SUMMARY OF THE INVENTION

Accordingly this invention provides an improved two roll sugarcane crushing mill comprising of a plurality of improved two roll mill modules in tandem, each of the said improved two roll mill module comprises a pair of main crushing roll consisting of a bottom roll and a top roll, the said bottom roll being rotatingly mounted in a pair of main frames/head stocks at the two ends, the said top roll being rotatingly mounted in a pair of top beams/lever arms at the two ends one end each of the said top beams being pivotally attached near the upper end of the head stocks towards feed side for swinging the said top beams along with the top roll, a hydraulic loading means pivotally attached between the other end of the said top beam and the base of the main frame, at least one feeder roller, with a scraper-cum-deflector with juice drainage means provided in the close proximity of the said main crushing rolls, the said feeder roller being mounted on an auxiliary frame and the said auxiliary frame being rigidly or pivotally mounted preferably on the said main frame for swingably adjusting the loading and setting the said feeder roller in a desired position.

### BRIEF DESCRIPTION OF THE SEVERAL VIEWS OF THE DRAWINGS

The invention will now be described with reference to accompanying drawings wherein:

FIG. 1 shows in schematic side view a conventional two roll sugar cane crushing mill module.

FIG. 2 shows in schematic side view an improved two roll sugarcane crushing mill module, according to an embodiment of this invention.

FIG. 3 shows in schematic side view an improved two roll sugarcane crushing mill module, according to another embodiment of this invention.

### DETAILED DESCRIPTION OF THE INVENTION

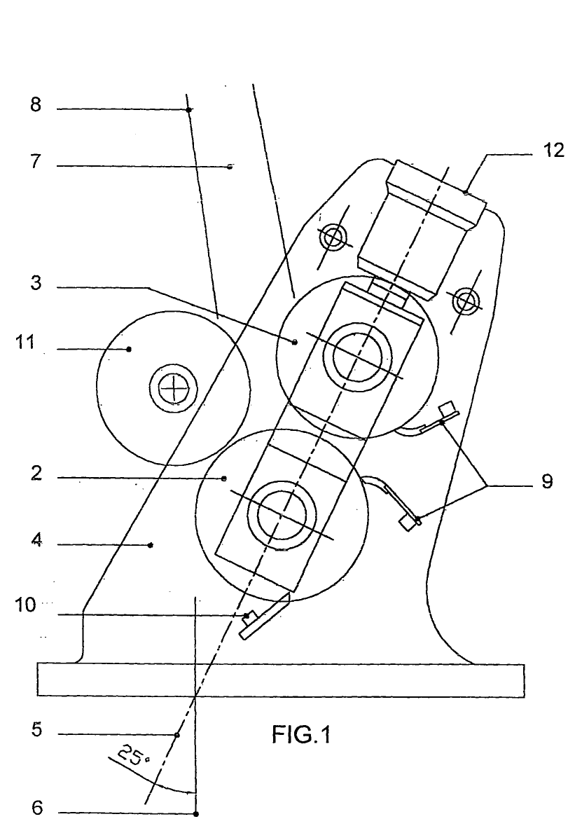

Referring to FIG. 1, a conventional two roll sugarcane crushing mill module (1) mainly comprises of a bottom roll (2) and a top roll (3) mounted in a pair of head stocks/closed frames (4) provided at two ends, with the help of bearings and wear plates. The central axis (5) of the bottom and top rolls (2,3) is kept inclined, at about 25 degrees, to the vertical axis (6) to take feed of prepared cane/bagasse (7) from a Donnelly chute (8). The bottom and top rolls are cast iron grooved rolls generally of almost equal size/diameter and provided with scrapers (9) and scraper cum knife (10) in a known manner.

Sometimes a grooved feeder roller (11) working as under feeder roller is also provided to compress the cane bagasse (7) before feeding to main crushing rolls. The feeder roller (11) is mounted on the frame (4) in a fixed manner. Sometimes two or more feeder rollers (not shown) are also provided to compact the cane/bagasse mat and stationary closed pressure chute (now shown) is provided in between the feeder roller and the main crushing rolls (2,3). The top roll (3) is directly loaded with the help of a hydraulic loading means (12) to maintain a pressure on the cane/bagasse mate passing between the top and bottom rolls. The disadvantages, further to as described hereinbefore, of the conventional two roll sugarcane crushing mill are, top roll bearings slide against the wear plates in the head stocks (4). There is horizontal reaction on sides, due to the driving TORQUE.

There is higher bearing pressure which makes, the sides of the top bearings and wear plates, to wear fast and uneven at top and bottom surfaces of sides of top bearings, this will create misalignment which will not allow free floating of the top roller. Once the misalignment is developed it is difficult to rectify it specifically during the same crushing season. Hydraulic load is to be given equal to cane/bagasse; reaction and whole hydraulic system is to be designed for such high pressure, due to direct loading. There is side reaction on the ram of the hydraulic system/loading means according to the driving force. Lubrication is required between side plates of top bearings and wears plates. Cast-iron grooved under feeder roller (11) needs precise setting and any variation in crushing poses problem of slippage and Donnelly chute gets overflowed resulting into long stoppage or down time of mill.

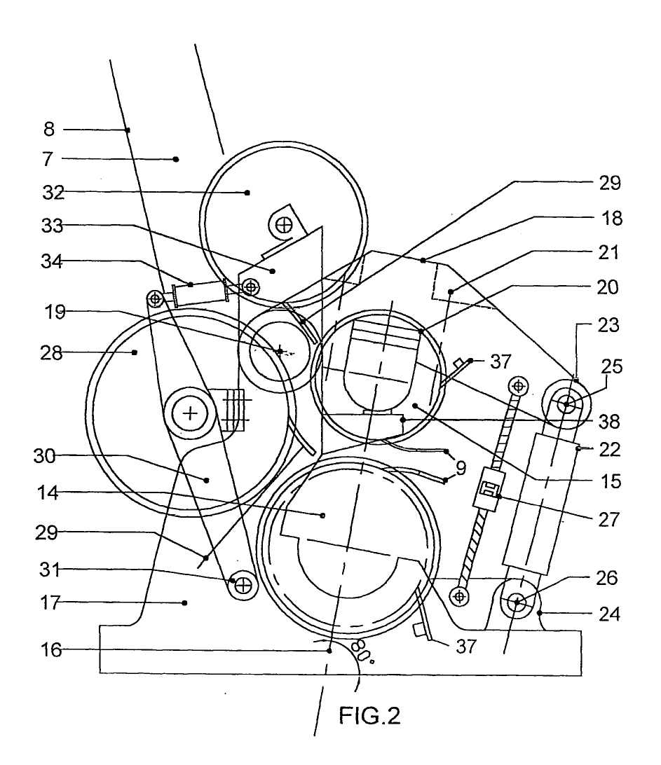

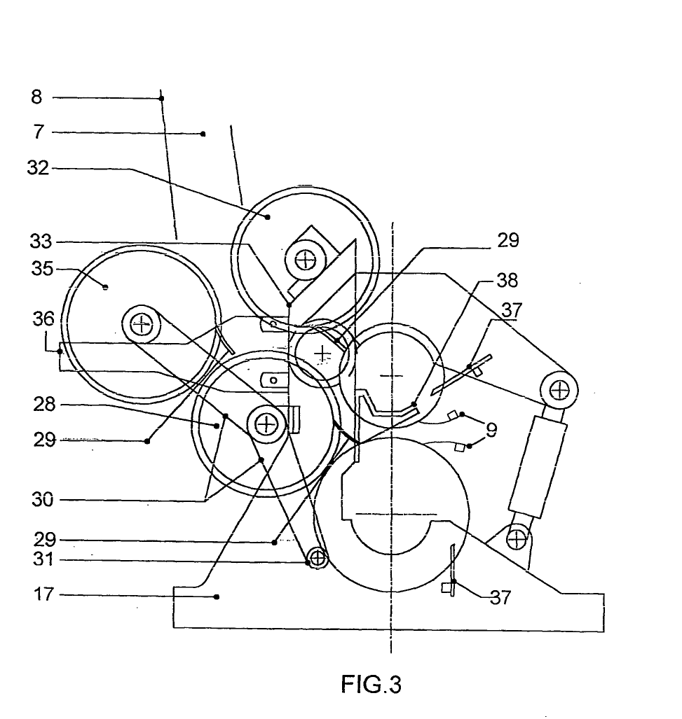

Referring to FIGS. 2 and 3, the improved two roll sugar cane crushing mill, according to this invention comprises a plurality of improved two roll mill modules (13) provided in tandem. Each of the improved two roll mill module (13) comprise a bottom roll (14) and a top roll (15). The bottom roll (14) is preferably of larger diameter than the top roll (15) diameter and the central axis (16) of the rolls (14,15) is kept substantially vertical. The bottom roll (14) is rotatingly mounted in a pair of main frames/headstocks (17) provided at the two ends which is open at on side. The top roll (15) is rotatingly mounted in top beam/lever arm (18) which is pivotally attached at the upper end of the main frame/head stock (17), at feed side with the help of pin (19). The top roll seats which are preferably spherical, semi-spherical or cylindrical are flexibly connected to the top beam (18) preferably with the help of flexible bolts or like means (21).

A hydraulic loading means/system (22) is flexibly connected in between the free end (23) of the top beam (18) and the base (24) of the main frame/head stock (17) with the help of pins (25,26). In case of failure of the hydraulic loading system (22), to keep the mill module in operating position, till the hydraulic system is repaired and replaced in position a mechanical means, such as tie rod/stud and nut (27) may also be additionally provided adjacent to the hydraulic loading means (22). At least one feeder roller (28) having a scraper-cum-deflector (29) with juice drainage means adjustably mounted therewith is provided in close proximity of the crushing rolls (14,15). The roller (28) is preferably mounted on an auxiliary frame (30) which is rigidly or pivotally attached on the main frame/headstock (17) with the help of pivot pin (31). As an alternative the auxiliary frame (30) may be rigidly or pivotally mounted on the separate base (not shown), adjacent to main frame (17). When two or more feeder rollers are provided for more compacting the cane/bagasse mat, the second feeder roller (32) as shown in FIG. 2 is mounted on the top of the main frame (17) directly or with the help of a bracket (33) attached or made integrally with the side main frame (17). The auxiliary frame (30) and the bracket (33) may be inter connected with the help of hydraulic means (34) for flexibly adjusting the gap between the feeder rollers (28,32) and or between the feeder rollers (28) and main crushing rolls (14,15) and thereby adjusting the loading on the cane/bagasse. (A known mechanical means may be provided in between the auxiliary frame and main frame from maintaining the desired gap settled in between the rollers.).

As shown in FIG. 3, when there are three feeder rollers (28,32 and 35), the feeder roller (35) may be mounted on a protrusion/bracket (36) attached in a known manner to the main frame/headstocks (17) or on the auxiliary frame (30). The feeder rollers (32) and (35) are mounted slidably for adjusting the gap in between the feeder rollers. A support or wedge (38) fixed to the main frame (17) may also be provided to support the top roll (15) at minimum gap level in between the crushing rolls. Mostly the under feeder rollers such as (28 and 35) are provided with scrapper-cum-deflector (29) while the over feeder roller such as (32) may be or may not be provided with a scraper-cum-deflector (29). The feeder rollers may be grooved rollers or toothed rollers or grooved roller with perforation/messacheart grooves or toothed perforated rollers or any combination of any such rollers. The bottom and top crushing rolls (14, 15) may be grooved perforated rollers (lotus) and or may be provided with messacheart grooves and knives (37) in a known manner and may also be provided with scrappers (9).

A plurality of improved mill modules (13) is provided in tandem. The last mill module may be replaced by an existing type three roll mill module in order to reduce the moisture contents of the bagasse being discharged at the final stage of crushing as a two roll mill module works on low pressure while three roll mill module works on high pressure thereby SQUEEZING out more water from the bagasse.

It will be clear from the above description with reference to figures, that hydraulic system of lower pressure will give more effective pressure (due to leverage) on the top roll (15). Top roll along with top beam can be swung upwards and hung up by known means and by just disconnecting the hydraulic system (22) from the end (23) by removing the pin (25), top and bottom roller can be taken out completely. The feeder rollers are mounted in close proximity of main crushing rolls hence stationary closed pressure chute is not required due to scraper-cum-deflector (29) provided with feeder roller (28) cane/bagasse mat once compressed will not expand and hence GRIPPING angle of the crushing rolls will be smaller.

A support or wedge (38) fixed to the main frame (17) may also be provided to support the top roll (15) at a minimum gap level in between the crushing rolls.

Advantages of the Invention

(a) There is no relative motion between top beam and top bearing, therefore no sliding and hence all the drawbacks due to sliding of bearing are eliminated.

(b) No lubrication required for bearing movement. It consumes less power due to elimination of sliding friction.

(c) There is rotational friction in the pivot pins of the top beam, instead of sliding friction and rotational friction is always better/less than sliding friction. Further the pivot pins for swings are provided with anti-friction bearings bringing down the frictional power almost negligible.

(d) There in provision of spherical seat arrangement between top beam and top roll bearings, which take misalignment due to uneven lifting of top roll. It also maintains the even bearing pressure for all positions of the floating top roll and improves the bearing life, requires less lubricants, and damages to the bearings surfaces.

(e) Hydraulic operating pressure given to cylinder according to this invention is much less than that required in conventional mills for the same load. Hence the hydraulic system is to be designed for less load hence is very economical and consumes less power.

(f) No oblique reactions on piston rod-as swinging type plain spherical bearings are provided at both the end of hydraulic cylinder, holding arrangement, hence hydraulic seal/system failure chances are considerably less, reducing the maintenance and mill down time.

(g) Minimum gap between two crushing rolls is maintained at the top beam position hence setting is very easy, lifts freely and sets itself in case the drive is given through bottom roll.

(h) Top roll bearing and bottom rolls bearing can be taken out with out taking out rolls.

(i) Top roll and bottom roll can be taken out without dismantling the top beam from its pivot and the rolls are slided out through the open side of the main frame.

(j) Easy and quick maintenance hence less down time and increased productivity of the mill.

(k) Substantial vertical axial plane mounting of the top and bottom rolls help juice drainage by gravity over the bottom roll.

(l) No precise setting is required for toothed feeder roller. It can accommodate any variation in cane/bagasse rate without any misalignment and hence once it is set, no resetting is required during the crushing season.

(m) One additional compression is achieved in a five roller mill (two main crushing rolls and three feeder rollers) in comparison with conventional mills.

(n) Same performance with less number of rollers thus, considerably low power consumption and as the rollers are less, maintenance cost is also less. Further effective and efficient pre-extraction of juice and its drainage is achieved which reduces liquid pressure in compression zone and thus reduces re-absorption factor and improves over all juice extraction.

(o) Pivot provided at the top roll supporting arm towards feed side facilitates easy and proper fitting and working of feeder roller.

(p) Specially suited for expansion to higher crushing rate with the addition of one or two mill modules according to this invention provided in the existing mill tandem.

The above description with reference to drawings is given just to understand the invention rather than to limit its scope.

I claim:

1. An improved two roll sugarcane crushing mill comprising
of a plurality of improved two roll mill modules in tandem, each of the said improved two roll mill modules comprise a pair of main crushing rolls consisting of a bottom roll and top roll, the said bottom roll being rotatingly mounted in a pair of main frames/head stocks at the two ends, the said top roll being rotatingly mounted in a pair of top beams/lever arms at the two ends, one end of each of the said top beams being pivotally attached near the upper end of the head stocks towards feed side for swinging the said top beams along with the top roll,
a hydraulic loading means pivotally attached between the end of the said top beam and the base of the main frame, at least one feeder roller with, a scrapper cum deflector with juice drainage means provided in the close proximity of the said main crushing rolls, the said feeder roller being mounted on an auxiliary frame and the said auxiliary frame being rigidly or pivotally mounted preferably on the said main frame for swingably adjusting the loading and setting the said feeder roller in desired position.

2. An improved two roll sugarcane crushing mill as claimed in claim 1 wherein the central axis of the said top and bottom rolls is substantially vertical.

3. An improved two roll sugarcane crushing mill as claimed in claims 1 or 2 wherein the said bottom roll is of substantially larger diameter than the said top roll diameter.

4. An improved two roll sugarcane crushing mill as claimed in claims 1,2 or 3 wherein the said auxiliary frame is rigidly or pivotally mounted on a separate base adjacent to the said main frame.

5. An improvement two roll sugarcane crushing mill as claimed in claims 1,2,3 or 4 wherein the said top beam, at its free end adjacent to the hydraulic loading means is additionally provided with a mechanical holding means connected in between the said base of the main frame and the said top beam, for holding the top roll in pressed/operating position in case the said hydraulic loading means goes out of order or becomes defective.

6. An improved two roll sugarcane crushing mill as claimed in claims 1,2,3,4, or 5 wherein the said main frame is provided with a support the top roll in a minimum gap position between the said top and bottom rolls.

7. An improved two roll sugarcane crushing mill as claimed in any of the preceding claims wherein the said top and bottom rolls are provided with any type of grooves on its peripheral surface and either one or both are having perforations forming lotus roll/s, in a know manner.

8. An improved two roll sugarcane crushing mill as claimed in any of the proceeding claims wherein either one or both of the said top and bottom crushing rolls is/are provided with messacheart grooves and knives in a known manner.

9. An improved two roll sugarcane crushing mill as claimed in any of the preceding claims wherein the said feeder roller provided for compacting the cane/bagasse mat are two in number and the said second feeder roller is mounted, at each end, on the top of the said main frame/headstock.

10. An improved two roll sugarcane crushing mill as claimed in claim 9, wherein the said auxiliary frame and the said main frame are flexible interconnected, near the upper ends, with the help of hydraulic means for variably adjusting the gap between the feeder rollers and/or between the feeder roller and main crushing rolls.

11. An improved two roll sugarcane crushing mill as claimed in claim-9, wherein the said auxiliary frame and the said main frame are rigidly inter connected near the upper ends with the help of known mechanical means for maintaining a desired setting of the said rollers.

12. An improved two roll sugarcane crushing mill as claimed in any of the preceding claims wherein the said feeder rollers provided for compacting the cane/bagasse mat are three in number and the said third feeder roller is mounted, at each end, on the said auxiliary frame above the said first feeder roller.

13. An improved two roll sugarcane crushing mill as claimed in any of the claims 1 to 11 wherein the said third feeder is mounted, at each end on a protrusion/bracket, either formed integrally, or fixed otherwise in a known manner, with the main frames and the bearings of the third roller feeder are slidable in the slots formed in said protrusion for adjusting the gap between the feeder roller.

14. An improved two roll sugarcane crushing mill as claimed in any of the preceding claims wherein the said feeder rollers are grooved roller/s or grooved perforated roller/s (lotus) or toothed roller/s or toothed perforated roller/s or any combination of these rollers.

15. An improved two roll sugarcane crushing mill as claimed in any of the preceding claims wherein each of the said feeder roller positioned as under feeder roller is provided with a scrapper-cum-deflector while the said feeder roller positioned as over feeder roller may or may not be provided with scrapper-cum-deflector.

16. An improved two roll sugarcane crushing mill as claimed in any of the preceding claims wherein the last module in the tandem of improved two roll mill modules is an existing three roll mill for squeezing out the maximum possible moisture from the bagasse, being discharged from the last mill.

17. An improved two roll sugarcane crushing mill substantially as herein described and illustrated in the accompanying drawing.
